(19) United States
(12) Patent Application Publication
(10) Pub. No.: US 2021/0036733 A1
(43) Pub. Date: Feb. 4, 2021

(54) SPUR MANAGEMENT IN MILLIMETER WAVE COMMUNICATIONS

(71) Applicant: QUALCOMM Incorporated, San Diego, CA (US)

(72) Inventors: Shay Landis, Hod Hasharon (IL); Igor Gutman, Ramat Gan (IL); Gideon Shlomo Kutz, Ramat Hasharon (IL); Ran Berliner, Kfar-Aviv (IL)

(21) Appl. No.: 16/530,504

(22) Filed: Aug. 2, 2019

(51) Int. Cl. H04B 1/7107; H04W 72/04; H04L 5/00

(52) U.S. Cl. CPC H04B 1/7107; H04B 2001/6912; H04L 5/0005; H04W 72/042

(57) ABSTRACT

Systems and methods to detect spurious responses (spurs) in association with mmWave wireless communications are described. Such spurs may originate internal to the receiver (internal spurs) or external to the receiver (external spurs) originated in the transmitter. Embodiments operate to identify received mmWave wireless communication signal spurs in symbols, or portions thereof, which do not have transmissions directed to the receiving device. mmWave spur detection implementations of embodiments can detect spurs in real-time operation of the receiving device. Such real-time spur detection facilitates operation by the receiving device to perform spur removal in real-time operation of the receiving device, thus enabling removal of both internal spurs and external spurs as well as dynamically adapting to different scenarios that cause different spurs. Other aspects and features are also claimed and described.

### TECHNICAL FIELD

Aspects of the present disclosure relate generally to wireless communication systems, and more particularly, to spur management in millimeter wave wireless communications. Certain embodiments of the technology discussed below can enable and provide spur detection and/or removal in millimeter wave wireless communications with respect to internal and external spurs.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

Spurious responses in receivers (often referred to as “spurs”) can case poor performance in a communication system. For example, a spur can cause high log-likelihood ratios (LLRs) with invalid signs. These scenarios are not generally consistent with an additive white Gaussian noise (AWGN) model on which a channel decoder may be designed (e.g., a receiver in a wireless communication system using low density parity check (LDPC) codes). Accordingly, various efforts to develop techniques for spur management have been made.

Current spur detection is typically based upon offline calibration of a receiver. These procedures generally include non-real-time measurement (e.g., such as in manufacturing or pre-deployment, to identify internal spurs), whereby a receiver may be preconfigured for corresponding spur rejection with respect to later wireless communication operation. Factory/offline characterization is generally costly and often results in non-optimal performance of a receiver because different scenarios will cause different spurs, with the number of combinations being very large and thus impractical to fully address with existing preconfiguration techniques.

### BRIEF SUMMARY OF SOME EMBODIMENTS

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Various aspects of the disclosure relate to spur management. Implementations may occur in one or more of spur detection and/or removal devices, systems, and methods. Aspects may be utilized in a variety of wireless communication scenarios, including millimeter wave scenarios (mmWave). In some mmWave scenarios, narrow mmWave beams are utilized and the nature and physical properties of mmWave beams can be leveraged to yield opportunities for improved wireless communication (e.g., via improved wireless receiver designs and operations). Spur management can aid in promoting improved communication via interference control and interference reduction.

In one aspect of the disclosure, a method of wireless communication includes receiving, by a wireless receiving device, a mmWave wireless communication signal intended for the wireless receiving device, and detecting, by the wireless receiving device in real-time operation, internal and external spurs associated with the mmWave wireless communication signal. The method may further include removing, by the wireless receiving device in real-time operation with the receiving, the internal and external spurs.

In an additional aspect of the disclosure, an apparatus for wireless communication includes means for receiving a mmWave wireless communication signal intended for a wireless receiving device, and means for detecting, in real-time operation, internal and external spurs associated with the mmWave wireless communication signal. The apparatus may further include means for removing, in real-time operation with the receiving the mmWave wireless communication signal, the internal and external spurs.

In an additional aspect of the disclosure, a non-transitory computer-readable medium having program code recorded thereon for wireless communication is provided. The program code of embodiments includes code to receive a mmWave wireless communication signal intended for a wireless receiving device, and detect, in real-time operation, internal and external spurs associated with the mmWave wireless communication signal. The program code may further include code to remove, in real-time operation with the receiving the mmWave wireless communication signal, the internal and external spurs.

In an additional aspect of the disclosure, an apparatus configured for wireless communication is provided. The apparatus includes at least one processor, and a memory coupled to the processor. The processor of embodiments is configured to receive a mmWave wireless communication signal intended for a wireless receiving device, and to detect, in real-time operation, internal and external spurs associated with the mmWave wireless communication signal. The processor may further be configured to remove, in real-time operation with the receiving the mmWave wireless communication signal, the internal and external spurs.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments the exemplary embodiments can be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of a wireless communication system according to some embodiments of the present disclosure.

FIG. 2 is a block diagram conceptually illustrating a design of a base station and a UE configured according to some embodiments of the present disclosure.

FIG. 3 is a flow diagram providing operation for spur management (e.g., mmWave spur detection and removal) according to some embodiments of the present disclosure.

FIG. 4 is a flow diagram providing detail with respect to mmWave spur detection according to some embodiments of the present disclosure.

FIG. 5 is a graph illustrating spurs detected above a noise floor in a symbol having a narrow band PDCCH present, in accordance with some embodiments of the present disclosure.

FIG. 6 is a block diagram conceptually illustrating a design of a UE configured to provide operation for spur management (e.g., mmWave spur detection and removal) according to some embodiments of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in communication as between two or more wireless devices in one or more wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks/systems/devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as GSM. 3GPP defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with Universal Terrestrial Radio Access Networks (UTRANs) in the case of a UMTS/GSM network. An operator network may also include one or more LTE networks, and/or one or more other networks. The various different network types may use different radio access technologies (RATs) and radio access networks (RANs).

An OFDMA network may implement a radio technology such as evolved UTRA (E-UTRA), IEEE 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD)/frequency division duplex (FDD) design; and advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

For clarity, certain aspects of the apparatus and techniques may be described below with reference to exemplary LTE implementations or in an LTE-centric way, and LTE terminology may be used as illustrative examples in portions of the description below; however, the description is not intended to be limited to LTE applications. Indeed, the present disclosure is concerned with shared access to wireless spectrum between networks using different radio access technologies or radio air interfaces, such as those of 5G NR.

Moreover, it should be understood that, in operation, wireless communication networks adapted according to the concepts herein may operate with any combination of licensed or unlicensed spectrum depending on loading and availability. Accordingly, it will be apparent to one of skill in the art that the systems, apparatus and methods described herein may be applied to other communications systems and applications than the particular examples provided.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and/or other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or OEM devices or systems incorporating one or more described aspects. In some practical settings, devices incorporating described aspects and features may also necessarily include additional components and features for implementation and practice of claimed and described embodiments. It is intended that innovations described herein may be practiced in a wide variety of implementations, including both large/small devices, chip-level components, multi-component systems (e.g. RF-chain, communication interface, processor), distributed arrangements, end-user devices, etc. of varying sizes, shapes, and constitution.

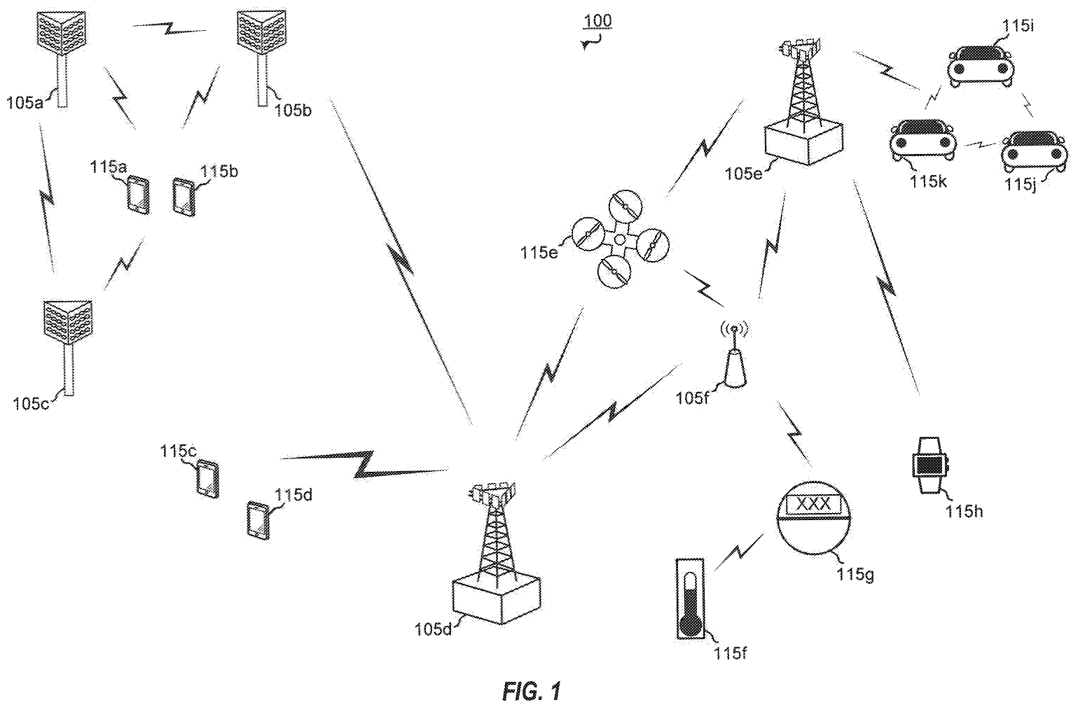

FIG. 1 shows wireless network 100 for communication according to some embodiments. Wireless network 100 may, for example, comprise a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station and/or a base station subsystem serving the coverage area, depending on the context in which the term is used. In implementations of wireless network 100 herein, base stations 105 may be associated with a same operator or different operators (e.g., wireless network 100 may comprise a plurality of operator wireless networks), and may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In other examples, each base station 105 and UE 115 may be operated by a single network operating entity.

A base station may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as user equipment (UE) in standards and specifications promulgated by the 3rd Generation Partnership Project (3GPP), such apparatus may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. Within the present document, a “mobile” apparatus or UE need not necessarily have a capability to move, and may be stationary. Some non-limiting examples of a mobile apparatus, such as may comprise embodiments of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an “Internet of things” (IoT) or “Internet of everything” (IoE) device such as an automotive or other transportation vehicle, a satellite radio, a global positioning system (GPS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the embodiment illustrated in FIG. 1 are examples of mobile smart phone-type devices accessing wireless network 100. A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a lightning bolt (e.g., communication link) indicates wireless transmissions between a UE and a serving base station, which is a base station designated to serve the UE on the downlink and/or uplink, or desired transmission between base stations, and backhaul transmissions between base stations. Backhaul communication between base stations of wireless network 100 may occur using wired and/or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of embodiments supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD/FDD communications, such as in a vehicle-to-vehicle (V2V) mesh network between UEs 115i-115k communicating with macro base station 105e.

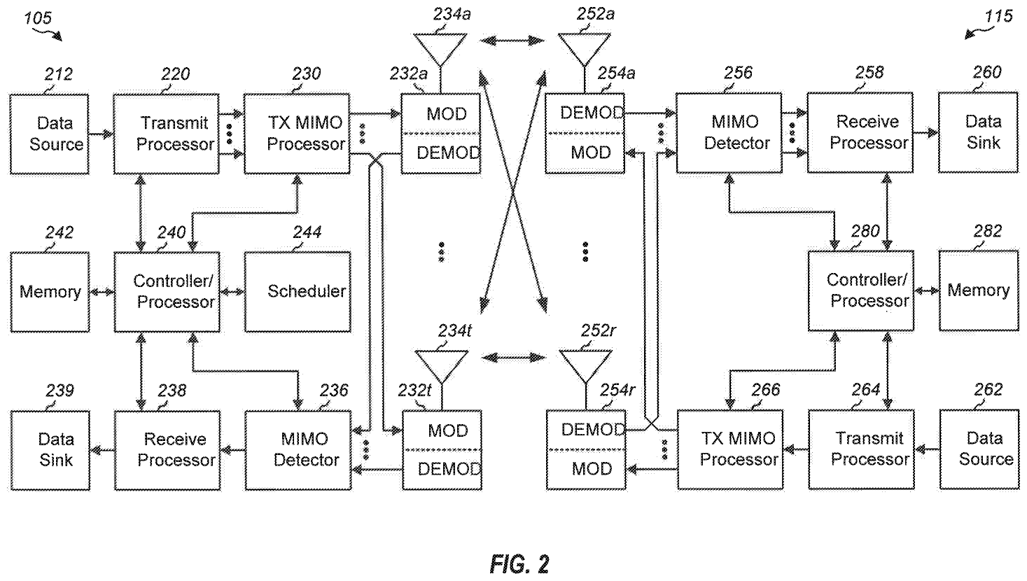

FIG. 2 shows a block diagram of a design of a base station 105 and a UE 115, which may be any of the base stations and one of the UEs in FIG. 1. For a restricted association scenario (as mentioned above), base station 105 may be small cell base station 105f in FIG. 1, and UE 115 may be UE 115c or 115D operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller/processor 240. The control information may be for the physical broadcast channel (PBCH), physical control format indicator channel (PCFICH), physical hybrid-ARQ (automatic repeat request) indicator channel (PHICH), physical downlink control channel (PDCCH), enhanced physical downlink control channel (EPDCCH), MTC physical downlink control channel (MPDCCH), etc. The data may be for the physical downlink shared channel (PDSCH), etc. Transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) multiple-input multiple-output (MIMO) processor 230 may perform spatial processing (e.g., precoding) on the data symbols, the control symbols, and/or the reference symbols, if applicable, and may provide output symbol streams to modulators (MODs) 232a through 232t. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller/processor 280.

On the uplink, at UE 115, transmit processor 264 may receive and process data (e.g., for the physical uplink shared channel (PUSCH)) from data source 262 and control information (e.g., for the physical uplink control channel (PUCCH)) from controller/processor 280. Transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Processor 238 may provide the decoded data to data sink 239 and the decoded control information to controller/processor 240.

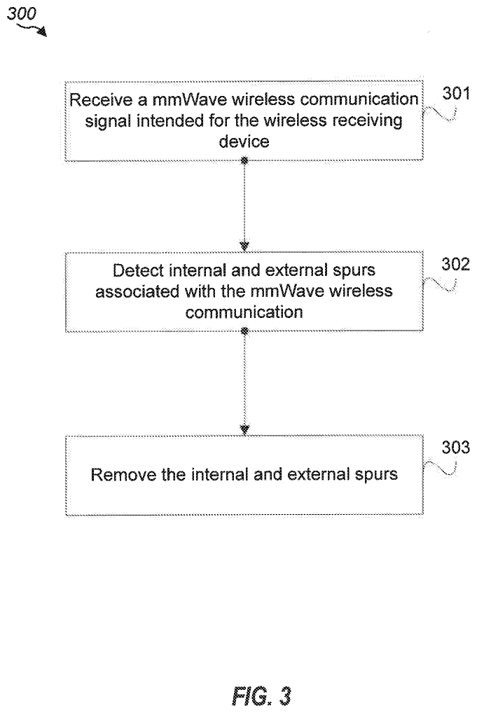

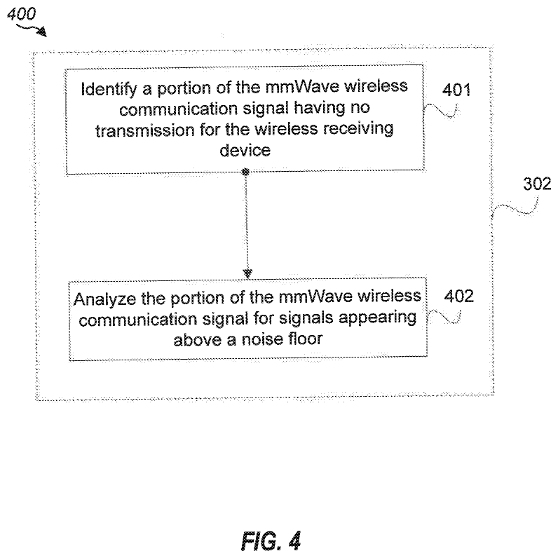

Controllers/processors 240 and 280 may direct the operation at base station 105 and UE 115, respectively. Controller/processor 240 and/or other processors and modules at base station 105 and/or controller/processor 280 and/or other processors and modules at UE 115 may perform or direct the execution of various processes for the techniques described herein, such as to perform or direct the execution illustrated in FIGS. 3 and 4, and/or other processes for the techniques described herein. Memories 242 and 282 may store data and program codes for base station 105 and UE 115, respectively. Scheduler 244 may schedule UEs for data transmission on the downlink and/or uplink.

Wireless communications systems operated by different network operating entities (e.g., network operators) may share spectrum. In some instances, a network operating entity may be configured to use an entirety of a designated shared spectrum for at least a period of time before another network operating entity uses the entirety of the designated shared spectrum for a different period of time. Thus, in order to allow network operating entities use of the full designated shared spectrum, and in order to mitigate interfering communications between the different network operating entities, certain resources (e.g., time) may be partitioned and allocated to the different network operating entities for certain types of communication.

For example, a network operating entity may be allocated certain time resources reserved for exclusive communication by the network operating entity using the entirety of the shared spectrum. The network operating entity may also be allocated other time resources where the entity is given priority over other network operating entities to communicate using the shared spectrum. These time resources, prioritized for use by the network operating entity, may be utilized by other network operating entities on an opportunistic basis if the prioritized network operating entity does not utilize the resources. Additional time resources may be allocated for any network operator to use on an opportunistic basis.

Access to the shared spectrum and the arbitration of time resources among different network operating entities may be centrally controlled by a separate entity, autonomously determined by a predefined arbitration scheme, or dynamically determined based on interactions between wireless nodes of the network operators.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen before talk (LBT) procedure such as a clear channel assessment (CCA) prior to communicating in order to determine whether the shared channel is available. A CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel and/or the acknowledge/negative-acknowledge (ACK/NACK) feedback for its own transmitted packets as a proxy for collisions.

Base station 105 and/or UE 115 of embodiments of the present disclosure are configured to detect spurious responses in their receivers (referred to herein as “spurs”) in mmWave wireless communications. Such spurs may originate internal to the receiver (internal spurs) or external to the receiver (external spurs) originated in the transmitter. Internal spurs may, for example, result from operation of circuitry of the wireless receiving device, such as occur when an oscillator or signal harmonic within the receiver falls on the receive frequency, the intermediate frequency or frequencies, the image frequency or frequencies or sometimes, on a sub multiple of any of these frequencies, or any other source of sinusoidal waveform that falls inside the relevant frequency band. External spurs, on the other hand, may comprise responses by the receiver to unwanted external signals such as may result from operation of circuitry of a wireless transmitting device that is a source of the mmWave wireless communication signal, or any other source of sinusoidal waveform that falls inside the relevant frequency band. Accordingly, base station 105 and/or UE 115 receiving a mmWave wireless communication signal (either device also referred to herein as a “wireless receiving device” or “receiving device” when referenced with respect to receive operation) provide spur detection in mmWave wireless communications with respect to spurs introduced by transmitter and/or receiver circuitry.

Base station 105 and UE 115 (e.g., base station 105a and UE 115a of FIG. 1) communicating using a mmWave wireless communication signal may utilize narrow beams (e.g., narrow analog beams, such as may be formed using a number of antennas, providing highly directional communications), such as to facilitate reliable communications in light of the essentially direct line-of-sight propagation characteristics of mmWave signals. For example, a transmitting device of base station 105a and UE 115a in wireless communication may utilize a narrow beam for transmission of the mmWave wireless communication signal intended for the receiving device of base station 105a and UE 115a, such as to avoid illuminating other ones of the base stations and UEs (e.g., base stations 105b, 105c, and 105d and UEs 115b, 115c, and 115d) of wireless network 100 with the mmWave wireless communication signal not intended for them. Additionally or alternatively, the receiving device of base station 105a and UE 115a may utilize a narrow beam for reception of the mmWave wireless communication signal intended for the receiving device of base station 105a and UE 115a, such as to avoid receiving signals intended for other ones of the base stations and UEs (e.g., base stations 105b, 105c, and 105d and UEs 115b, 115c, and 115d) of wireless network 100. Accordingly, most transmissions not intended for the receiving device of the base station and UE in wireless communication will not be received by that receiving device (e.g., when data is not allocated to the UE, substantially no signal will be received by the UE where narrow analog beams are used by the base station and/or UE for the mmWave wireless communication signal).

Embodiments of mmWave spur management techniques (e.g., spur detection and/or spur removal) implemented in accordance with concepts of the present disclosure can leverage mmWave properties. As one example, embodiments can utilize the relatively isolated nature of mmWave wireless communication signals at a receiving device to detect internal and external spurs (e.g., spurs introduced by transmitter and/or receiver circuitry) in mmWave wireless communications. A spur detection technique of embodiments operates to identify received mmWave wireless communication signal spurs in symbols, or portions thereof. Detection can occur at receiving devices in these identified symbols (or portions thereof), which do not have transmissions directed to the receiving device. Spur detection can be considered as one aspect of spur management according to the various techniques discussed herein.

Spur detection may be carried out in a variety of manners. In operation according to some embodiments, one or more symbols allocated to a receiving device having no transmission intended for the receiving device (e.g., a symbol of a PDCCH assigned to the receiving device which is unused in a particular frame) may be analyzed by spur detection logic (and/or circuitry) of the receiving device to identify spurs. Additionally or alternatively, an unused portion of one or more symbol allocated to the receiving device having a partial bandwidth transmission for the receiving device (e.g., a symbol of a PDCCH assigned to the receiving device which includes a narrow band PDCCH transmission thereby providing a partial transmission in frequency domain) may be analyzed by spur detection logic of the receiving device to identify spurs. Although the foregoing examples mention PDCCH symbols, the concept may be applied to various other symbols (e.g., of the same or differing physical channels) which are known to have no transmission for the receiving device. Embodiments may, for example, may utilize PDSCH/CSI-RS (channel state information reference signals) with partial allocation.

Spur management techniques discussed herein may be utilized for a variety of communication and spur scenarios. For example, mmWave spur detection implementations of embodiments of the present disclosure can detect spurs, whether internal or external spurs. Detection can also occur in real-time operation of a receiving device (i.e., spur detection performed contemporaneously with the wireless communication session from which the wireless communication signal analyzed for spur detection is received). Real-time spur detection facilitates operation by a receiving device to perform spur removal in real-time operation of the receiving device (i.e., spur removal performed contemporaneously with the wireless communication session within which the spur is detected). This enables removal of both internal spurs (e.g., resulting from operation of circuitry of the wireless receiving device) and external spurs (e.g., resulting from operation of circuitry of a wireless transmitting device). And it also enables dynamically adapting to different scenarios that cause different spurs (e.g., brought about by dynamic communication channels and/or device manufacturing issues). In particular, real-time spur detection and removal in accordance with embodiments of a 5G NR downlink implementation provide for spur cancelation as the spurs were estimated in the same slot they exist. The use of mmWave spur detection in accordance with embodiments of the present disclosure thus provides improved performance due to spur mitigation in a data path (e.g., PDCCH, PDSCH, CSI-RS, etc.) over traditional spur removal techniques using factory/offline characterization.

Referring now to FIG. 3, flow diagram 300 providing operation for mmWave spur detection and removal according to embodiments of the present disclosure is shown. The functions of flow 300 may, for example, be performed by a receiving device of a mmWave wireless communication link (e.g., one of base stations 105 or UEs 115 receiving a mmWave wireless communication signal). To simplify the discussion of flow 300 and to aid in understanding concepts of the present disclosure, exemplary embodiments are discussed below with respect to downlink wireless communications wherein a UE is operating as a receiving device. It should be understood, however, that the embodiments of the present disclosure may additionally or alternatively be implemented with respect to uplink wireless communications wherein a base station is operating as a receiving device. Embodiments may also be utilized in other network settings in which receivers may face spur challenges.

At block 301 of the embodiment of flow 300 illustrated in FIG. 3, a wireless receiving device receives a mmWave wireless communication signal intended for the wireless receiving device. For example, UE 115 may receive a transmission on one or more wireless communication resources (e.g., channels, frequencies, frames, time slots, resource blocks, etc. assigned or otherwise allocated for transmission intended for the UE). In operation according to embodiments, receive chain components of UE 115 (e.g., antennas 252a-252r, demods 254a-254r, MIMO detector 256, and receive processor 258) cooperate to receive the mmWave wireless communication signal. In operation according to embodiments, the receive chain components, or some portion thereof, are controlled (e.g., by controller/processor 280) to form a narrow beam (e.g., directed toward one of base stations 105 operating as the transmitter device for the mmWave wireless communication signal intended for UE 115) with which the mmWave wireless communication signal is received. Correspondingly, transmit chain components of base station 105 (e.g., transmit processor 220, TX MIMO processor 230, mods 232a-232t, and antennas 234a-234t) may be controlled (e.g., by controller/processor 240) to form a narrow beam (e.g., directed toward UE 115) with which the mmWave wireless communication signal is transmitted. Logic of UE 115 (e.g., code stored by memory 282 executed by controller/processor 280 for wireless communication signal processing and analysis) may operate to recognize the mmWave wireless communication signal, or some portion thereof, as being intended for the UE (e.g., by analyzing channel and/or resource assignment information, such as stored by memory 282, analyzing information within the received signal, such as packet headers or other control data, etc.).

Having received a mmWave wireless communication signal intended for the wireless receiving device, processing according to the illustrated embodiment of flow 300 proceeds. At block 302 spurs associated with the mmWave wireless communication are detected. Spur detection can be done by analyzing received signals carried out by circuitry and/or logic present at a receiver. For example, in operation at block 302 of embodiments, a wireless receiving device detects, in real-time operation, internal and external spurs associated with the mmWave wireless communication. Circuitry or logic of UE 115 (e.g., code stored by memory 282 executed by controller/processor 280 for spur detection) may operate to detect spurs. Whether introduced by transmitter and/or receiver circuitry, identifying spurs in symbols of received mmWave wireless communication signal, or portions thereof, can occur via analyzing transmissions received by but which do not have transmissions directed to the receiving device.

FIG. 4 shows additional detail with respect to operation to detect spurs associated with the mmWave wireless communication, as may be performed at block 302 of embodiments of flow 300. In operation according to flow 400 of the illustrated embodiment, at least a portion of the mmWave wireless communication signal intended for the wireless receiving device having no transmission for the wireless receiving device is identified. For example, logic of UE 115 (e.g., code stored by memory 282 executed by controller/processor 280 for spur detection) may identify one or more symbols allocated to UE 115 having no transmission for the UE (e.g., a symbol of a PDCCH assigned to the UE which is unused in a particular frame) may be analyzed by spur detection circuitry or logic of the UE to identify spurs. As a specific example, the UE may receive PDCCH on the first three symbols in a slot and PDSCH data on the remaining symbols in the slot. If no PDCCH is found on one or more of the first three symbols the spur detection logic of the UE may operate to identify that symbol for use in detecting spurs. That is, absence or presence of data may be used by a receiver to identify signals or signal portions to be used for spur detection. Additionally or alternatively, the logic of UE 115 may identify an unused portion of one or more symbol allocated to the receiving device (e.g., those having a partial bandwidth transmission for the receiving device). As a specific example, the UE may receive PDCCH on the first three symbols in a slot, as discussed above. If a narrow band PDCCH transmission is found on one or more of the first three symbols the spur detection logic of the UE may operate to identify a portion of that symbol not occupied by the PDCCH for use in detecting spurs.

Having identified one or more portions of a mmWave wireless communication signal having no transmission for a wireless receiving device, processing according to the illustrated embodiment of flow 400 proceeds. At block 402 analyzing an identified portion of the mmWave wireless communication signal for spurs can occur. In operation according to flow 400 of the illustrated embodiment, a portion of the mmWave wireless communication signal is analyzed for signals having signal characteristics relative to a reference (e.g., appearing above and/or below a noise floor). Noise floor comparisons are types of physical property-based comparisons that can yield relative determinations associated with spur detection. Spurs occurring in a wireless signal may create noise in the signal such that comparison with a known parameter (e.g., a noise floor) can yield a positive or negative presence of a spur. In some scenarios, absence of noise or reduced noise relative to a noise floor may also yield positive detection. In some scenarios, the noise floor may be based on signal to noise type characteristics and in other scenarios may be associated with thermal noise (e.g., a thermal noise floor).

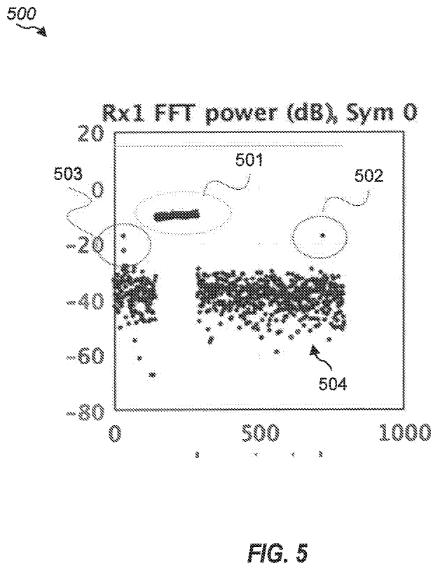

Spur detection techniques utilizing noise floor comparisons can be implemented in a variety of manners. For example, because a portion of the received mmWave wireless communication signal being analyzed has been identified as not having a transmission for UE 115, detection circuitry and/or logic of UE 115 (e.g., code stored by memory 282 executed by controller/processor 280 for spur detection) can analyze that portion of the received mmWave wireless communication signal and may detect as spurs any signals present which appear above the thermal noise floor. This example is illustrated in power/frequency graph 500 of FIG. 5.

The graph of FIG. 5 graphically depicts signal level position relative to a noise floor. For example, a narrow band PDCCH 501 is present in the symbol and spurs 502 and 503 are detected in the frequency domain as signals or other energy appearing above noise floor 504 in portions of the symbol having no transmission for the wireless receiving device (e.g., spurs which occur in the symbol carrying PDDCH but which are outside the PDCCH bandwidth). The detected spurs may, for example, be identified as a spurious signal present (e.g., at a particular frequency or frequency band). Spurs 502 and 503 may be internal spurs, external spurs, or a combination thereof, and are readily detectable (e.g., by circuitry and/or logic of the receiving device). It should further be appreciated that the foregoing detection of spurs may be performed in real-time operation of the receiving device by the mmWave spur detection implementations of embodiments of the present disclosure.

Detection of spurs by operation of mmWave spur detection implementations herein may be utilized in several ways for various purposes. Referring again to FIG. 3, the illustrated embodiment of flow 300 provides for removal of detected spurs. In operation at block 302 of embodiments, the wireless receiving device removes, in real-time operation, internal and/or external spurs. For example, logic of UE 115 (e.g., code stored by memory 282 executed by controller/processor 280 for spur removal) may configure one or more filters (e.g., filters of receive processor 258) to provide one or more filter configurations (e.g., control bandpass, band-stop, low-pass, and/or high-pass filters) to remove the detected spurs, or some portion thereof. Filtering out spurs in this manner removes the spurs as another element of spur management. Filters utilized as part of spur management may have static, dynamic, and/or controllable filtering ranges.

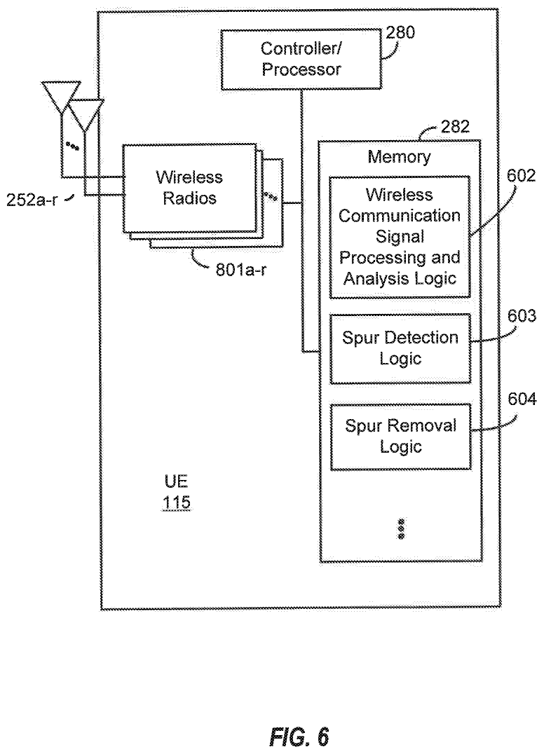

FIGS. 3 and 4 are a block diagrams illustrating example blocks executed to implement one aspect of the present disclosure. The example blocks will also be described with respect to UE 115 as illustrated in FIG. 6. FIG. 6 is a block diagram illustrating UE 115 configured according to some aspects of the present disclosure. UE 115 includes the structure, hardware, and components as illustrated for UE 115 of FIG. 2. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 1500a-r and antennas 252a-r. Wireless radios 1500a-r includes various components and hardware, as illustrated in FIG. 2 for UE 115, including modulator/demodulators 254a-r, MIMO detector 256, receive processor 258, transmit processor 264, and TX MIMO processor 266. Memory 282 of the embodiment of UE 115 shown in FIG. 6 stores logic and data for providing mmWave spur detection and removal according to embodiments. For example, wireless communication signal processing and analysis logic 602 may comprise instructions defining operation in accordance with flow 300 of FIG. 3 to recognize a mmWave wireless communication signal, or some portion thereof, as being intended for the UE. Spur detection logic 603 may comprise instructions defining operation in accordance with flow 300 of FIG. 3 and/or flow 400 of FIG. 4 to detect spurs associated with the mmWave wireless communication. Spur removal logic 604 may comprise instructions defining operation in accordance with flow 300 of FIG. 3 to remove spurs detected in association with the mmWave wireless communication.

In some aspects, spur management, spur detection, and/or spur removal may include a wireless receiving device receiving a mmWave wireless communication signal intended for the wireless receiving device and detecting, in real-time operation, internal and external spurs associated with the mmWave wireless communication signal. Spur management, spur detection, and/or spur removal of aspects may further include the wireless receiving device removing, in real-time operation, the internal and external spurs.

Spur management, spur detection, and/or spur removal may include additional aspects, such as any single aspect or any combination of aspects described below and/or in connection with one or more other processes described elsewhere herein.

In a first aspect, the mmWave wireless communication signal is received by the wireless receiving device using a narrow beam.

In a second aspect, alone or in combination with the first aspect, the mmWave wireless communication signal is received by the wireless receiving device from a narrow beam transmission by a wireless transmitting device.

In a third aspect, alone or in combination with one or more of the first and second aspects, the detecting spurs associated with the mmWave wireless communication signal comprises identifying a portion of the mmWave wireless communication signal having no transmission for the wireless receiving device, and analyzing the portion of the mmWave wireless communication signal for signals appearing relative to a noise floor.

In a fourth aspect, alone or in combination with one or more of the first through third aspects, the portion of the mmWave wireless communication signal comprises a partial transmission in frequency domain.

In a fifth aspect, alone or in combination with one or more of the first through fourth aspects, the portion of the mmWave wireless communication signal identified comprises a downlink symbol reserved for physical downlink control channel (PDCCH) communication with the wireless receiving device.

In a sixth aspect, alone or in combination with one or more of the first through fifth aspects, no PDCCH transmission is present in the downlink symbol.

In a seventh aspect, alone or in combination with one or more of the first through sixth aspects, a PDCCH transmission is present in the downlink symbol and the portion of the mmWave wireless communication signal identified comprises a portion of the downlink symbol not occupied by the PDCCH transmission.

In an eighth aspect, alone or in combination with one or more of the first through seventh aspects, the portion of the mmWave wireless communication signal identified comprises a downlink symbol having no transmission present for the wireless receiving device.

In a ninth aspect, alone or in combination with one or more of the first through eighth aspects, the real-time operation is performed in real-time with the receiving the mmWave wireless communication signal by the receiving device.

In a tenth aspect, alone or in combination with one or more of the first through ninth aspects, the real-time operation performs the detecting and removing of the internal and external spurs contemporaneously with a wireless communication session from which the wireless communication signal is received by the receiving device.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules described herein (e.g., the functional blocks and modules in FIG. 2) may comprise processors, electronics devices, hardware devices, electronics components, logical circuits, memories, software codes, firmware codes, etc., or any combination thereof. In addition, features discussed herein relating to spur management, spur detection, and spur removal may be implemented via specialized processor circuitry, via executable instructions, and/or combinations thereof.

Those of skill would further appreciate that the various illustrative logical blocks, modules, circuits, and algorithm steps (e.g., the logical blocks in FIGS. 3 and 4) described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
receiving, by a wireless receiving device, a millimeter wave (mmWave) wireless communication signal intended for the wireless receiving device;
detecting, by the wireless receiving device in real-time operation, internal spurs originated by the wireless receiving device associated with the mmWave wireless communication signal and external spurs originated by a wireless transmitting device associated with the mmWave wireless communication signal; and
removing, by the wireless receiving device in real-time operation, the internal and external spurs.

2. The method of claim 1, wherein the mmWave wireless communication signal is received by the wireless receiving device either using a narrow beam or from a narrow beam transmission by a wireless transmitting device, or a combination thereof.

3. The method of claim 1, wherein the detecting spurs associated with the mmWave wireless communication signal comprises:
identifying a portion of the mmWave wireless communication signal having no transmission for the wireless receiving device; and
analyzing the portion of the mmWave wireless communication signal for signals appearing relative to a noise floor.

4. The method of claim 3, wherein the portion of the mmWave wireless communication signal comprises a partial transmission in frequency domain.

5. The method of claim 3, wherein the portion of the mmWave wireless communication signal identified comprises a downlink symbol reserved for physical downlink control channel (PDCCH) communication with the wireless receiving device.

6. The method of claim 5, wherein no PDCCH transmission is present in the downlink symbol.

7. The method of claim 5, wherein a PDCCH transmission is present in the downlink symbol and the portion of the mmWave wireless communication signal identified comprises a portion of the downlink symbol not occupied by the PDCCH transmission.

8. The method of claim 3, wherein the portion of the mmWave wireless communication signal identified comprises a downlink symbol having no transmission present for the wireless receiving device.

9. The method of claim 1, wherein the real-time operation is performed in real-time with the receiving the mmWave wireless communication signal by the receiving device.

10. The method of claim 9, wherein the real-time operation performs the detecting and removing of the internal and external spurs contemporaneously with a wireless communication session from which the wireless communication signal is received by the receiving device.

11. A non-transitory computer-readable medium having program code recorded thereon, the program code comprising:
program code executable by a computer for causing the computer to
receive a millimeter wave (mmWave) wireless communication signal intended for a wireless receiving device;
detect, in real-time operation, internal spurs originated by the wireless receiving device associated with the mmWave wireless communication signal and external spurs originated by a wireless transmitting device associated with the mmWave wireless communication signal; and
remove, in real-time operation, the internal and external spurs.

12. The non-transitory computer-readable medium of claim 11, wherein the mmWave wireless communication signal is received by the wireless receiving device either using a narrow beam or from a narrow beam transmission by a wireless transmitting device, or a combination thereof.

13. The non-transitory computer-readable medium of claim 11, wherein the program code further causes the computer to:
identify a portion of the mmWave wireless communication signal having no transmission for the wireless receiving device; and
analyze the portion of the mmWave wireless communication signal for signals appearing relative to a noise floor.

14. The non-transitory computer-readable medium of claim 13, wherein the portion of the mmWave wireless communication signal comprises a partial transmission in frequency domain.

15. The non-transitory computer-readable medium of claim 13, wherein the portion of the mmWave wireless communication signal identified comprises a downlink symbol reserved for physical downlink control channel (PDCCH) communication with the wireless receiving device.

16. The non-transitory computer-readable medium of claim 15, wherein no PDCCH transmission is present in the downlink symbol.

17. The non-transitory computer-readable medium of claim 15, wherein a PDCCH transmission is present in the downlink symbol and the portion of the mmWave wireless communication signal identified comprises a portion of the downlink symbol not occupied by the PDCCH transmission.

18. The non-transitory computer-readable medium of claim 13, wherein the portion of the mmWave wireless communication signal identified comprises a downlink symbol having no transmission present for the wireless receiving device.

19. The non-transitory computer-readable medium of claim 11, wherein the real-time operation is performed in real-time with receiving the mmWave wireless communication signal by the receiving device.

20. The non-transitory computer-readable medium of claim 19, wherein the real-time operation performs detecting and removing of the internal and external spurs contemporaneously with a wireless communication session from which the wireless communication signal is received by the receiving device.

21. An apparatus configured for wireless communication, the apparatus comprising:
at least one processor; and
a memory coupled to the at least one processor, wherein the at least one processor is configured:
to receive a millimeter wave (mmWave) wireless communication signal intended for a wireless receiving device;
to detect, in real-time operation, internal spurs originated by the wireless receiving device associated with the mmWave wireless communication signal and external spurs originated by a wireless transmitting device associated with the mmWave wireless communication signal; and
to remove, in real-time operation, the internal and external spurs.

22. The apparatus of claim 21, wherein the mmWave wireless communication signal is received by the wireless receiving device either using a narrow beam or from a narrow beam transmission by a wireless transmitting device, or a combination thereof.

23. The apparatus of claim 21, wherein the at least one processor is further configured:
to identify a portion of the mmWave wireless communication signal having no transmission for the wireless receiving device; and
to analyze the portion of the mmWave wireless communication signal for signals appearing relative to a noise floor.

24. The apparatus of claim 23, wherein the portion of the mmWave wireless communication signal comprises a partial transmission in frequency domain.

25. The apparatus of claim 23, wherein the portion of the mmWave wireless communication signal identified comprises a downlink symbol reserved for physical downlink control channel (PDCCH) communication with the wireless receiving device.

26. The apparatus of claim 25, wherein no PDCCH transmission is present in the downlink symbol.

27. The apparatus of claim 25, wherein a PDCCH transmission is present in the downlink symbol and the portion of the mmWave wireless communication signal identified comprises a portion of the downlink symbol not occupied by the PDCCH transmission.

28. The apparatus of claim 23, wherein the portion of the mmWave wireless communication signal identified comprises a downlink symbol having no transmission present for the wireless receiving device.

29. (canceled)

30. (canceled)

31. The method of claim 1, wherein the internal spurs include a first one or more harmonic signals resulting from operation of circuitry of the wireless receiving device, and wherein the external spurs include a second one or more harmonic signals resulting from operation of circuitry of the wireless transmitting device.

32. The method of claim 31, wherein the first and second one or more harmonic signals fall within a frequency band corresponding to the received mmWave wireless communication signal.
